(19) United States
(12) Patent Application Publication
(10) Pub. No.: US 2006/0087552 A1
(43) Pub. Date: Apr. 27, 2006

(54) Device for the digital radio transmission of data comprising video information

(75) Inventor: Frederic Trouve, Mions (FR)

Correspondence Address: HESLIN ROTHENBERG FARLEY & MESITI PC, 5 COLUMBIA CIRCLE, ALBANY, NY, 12203, US

(73) Assignee: AVENIR NUMERIC'S, Saint Maurice de Beynost (FR)

(21) Appl. No.: 10/540,468

(22) PCT Filed: Dec. 23, 2003
(86) PCT No.: PCT/FR03/03876

§ 371 Date: Jun. 23, 2005

(30) Foreign Application Priority Data
Dec. 27, 2002 (FR) 02/16768

(51) Int. Cl. H04N 7/14

(52) U.S. Cl. 348/14.01; 348/231.99

(57) ABSTRACT

The invention relates to a device for the digital radio transmission of data comprising video information. The inventive device is characterised in that it comprises: a video acquisition camera; a compression stage which can generate a digital signal from the signal originating from the video acquisition camera, with a compression ratio which is at least greater than 1:300; a conforming stage which can insert the compressed video signal into a frame; a digital modulation stage which can generate a digital radio signal; a transmission/reception stage which can transmit the digital radio signal in a pre-determined frequency band to analogue transmission devices and which can receive signals comprising frames with the same structure transmitted by said analogue devices.

### FIELD OF THE INVENTION

The invention relates to the field of digital transmission systems. It refers, in particular, to transmission devices that can be connected in a network in order to transmit video type signals by radio.

The invention has a special application in implementing networks of remote monitoring cameras in locations having a very wide range of configurations and, in particular, locations where it is difficult to install traditional wired devices.

### DESCRIPTION OF THE PRIOR ART

Existing solutions in the field of video remote monitoring are limited due to numerous constraints associated with the technologies used. Systems have already been proposed in which a camera, fitted. with a radio transmitter, transmits to a single receiver associated with a video processing system. Such systems are marketed by the firm MICROWAVE RADIO COMMUNICATION in particular. This type of system is used especially in the field of TV reporting but is unsuitable for remote monitoring which requires that several images can be analysed simultaneously.

Other solutions have already been suggested in which several cameras, each with its own transmitter, transmit information to a single receiver associated with the video processing chain.

This type of solution has the drawback of making it necessary to site the receiver at a location where it is within range of all the transmitters. This therefore limits the extent of the coverage of the system for a given transmit power level. In addition, complex configurations having multiple boxed-in zones cannot be equipped with this type of system.

In addition, the technologies used, especially the transmission protocols, do not make it possible to send a large amount of video information so this type of system is therefore not suitable for providing remote monitoring.

Document US 2002/009154 discloses a domestic system which makes it possible to connect various electronic and computer equipment to a very small local area network. This type of system operates with an IEEE 1394 interface which requires considerable bandwidth in order to transport video bit streams so that it cannot be used, under any circumstances, in a radio remote monitoring system that includes a large number of cameras.

The first objective of the invention is to make it possible to connect a very large number of video cameras to a central system capable of ensuring the analysis, backup or any other operation on all the video information acquired by each of the cameras.

Another objective of the invention is also to make it possible to deploy this type of installation extremely simply without the need for any expensive wired infrastructure.

Another objective is to make it possible to set up this type of installation without any limits in terms of the configuration of the area that is to be covered.

### DESCRIPTION OF THE INVENTION

The invention therefore relates to a transmission device for the digital radio transmission of data, including video information.

According to the invention, this device is characterised in that it comprises:
a video acquisition camera,
a compression stage capable of generating a digital signal from the signal output by the video acquisition camera with a compression rate at least in excess of 1:300,
a shaper stage capable of inserting the compressed video signal into a frame,
a digital modulation stage capable of generating a digital radio signal,
a transceiver stage capable of transmitting the digital radio signal in a predetermined frequency band to similar transmission devices and capable of receiving signals that include frames having the same structure transmitted by similar devices.

In other words, the invention involves building a network that links each of the unitary devices. A data stream is therefore ensured between each of the devices which incorporates the video signal from its own camera into this stream in real time. Each of the devices therefore receives all the video signals from all the devices that are linked to the network and therefore ensures transmission in respect of those devices that are within its transmitted and received fields.

The network of these unitary devices therefore ensures meshing which makes it possible to deploy the network over a coverage area that can be very extensive and is incomparably larger than that of existing devices. In addition, since each of the devices in the network ensures propagation of all the video signals, it is possible to deploy this network in zones having extremely uneven configurations because if only one isolated device is connected to another device in the network, it is possible to route its video signal to the supervision system.

In practice, this means that a camera can be set up in a cramped area if it is within reception and transmission range of another device in an area that is more obstacle free.

In addition, this meshing makes it possible to ensure a certain degree of redundancy if one of the devices should fail.

Incorporating a very large number of video signals in order to allow, in particular, remote monitoring tasks is possible thanks to the use of an extremely high compression rate in excess of 300. This type of compression can be obtained in particular by using MPEG-4 format compression algorithms with possible bit rate adaptation.

In practice, the video acquisition camera can generate either an analog signal or a digital signal. The compression rate is determined in relation to the bandwidth of the equivalent digitised analog signal.

In one particular embodiment, the compression stage can be built into the video acquisition camera. Nevertheless, it can be separate from the latter and constitute a special-purpose electronic circuit.

Advantageously and in practice, each device may comprise means of modifying the viewing angle of the camera remotely, i.e. each camera may have zoom functions or be panned or moved in order to scan a wider area.

In the latter case, provision may be made to physically separate the moveable camera from the transceiver stage in order to prevent Doppler effects that might interfere with radio transmission and reception.

If the device is a unitary physical assembly, these phenomena are taken into account when specifying its transmission and reception performance data.

In order to make it easier to set up these devices in locations that are difficult to access, especially in terms of availability of electrical infrastructure, one may, advantageously, include self-contained means of supplying power, e.g. solar photovoltaic panels or equivalent means. The type of camera used may allow night time monitoring or, more generally speaking, be suitable for particular visibility conditions.

In practice, each device includes its compressed video signal in a frame that is structured in a predetermined manner in accordance with known techniques referred to as a “transport stream.”. The shaper stage provides multiplexing which makes it possible to insert data into the general frame.

Subsequently, this frame is routed to the digital modulation stage which may use various techniques to generate radio-frequency signals. Modulation may be of the Coded Orthogonal Frequency Division Multiplexing (COFDM) type.

Other types of coding, especially Wideband Code Division Multiple Access (WCDMA) can be used.

Other coding systems that are a mixture, for example, of the two types stated above can also be used.

The radio signal thus generated can be transmitted or received in different transmit modes, especially in Single Frequency Network (SFN) mode or Multiple Frequency Network (MFN) mode.

In practice, the transceiver stage may have either a local directional antenna or a distributed antenna which may be in the form of a radiating cable, e.g. a coaxial cable.

### BRIEF DESCRIPTION OF THE DRAWINGS

The manner in which the invention is implemented and its advantages will become apparent from the following description of the embodiment, merely by way of example, reference being made to the accompanying drawings:

FIG. 1 is a general view of an area equipped with a device in accordance with the invention.

FIG. 2 is a block diagram showing the operation of a unitary device.

### DESCRIPTION OF THE PREFERRED EMBODIMENTS

As already stated, the invention relates to a device for digital radio transmission, including video information, which has a particular application in the field of remote monitoring.

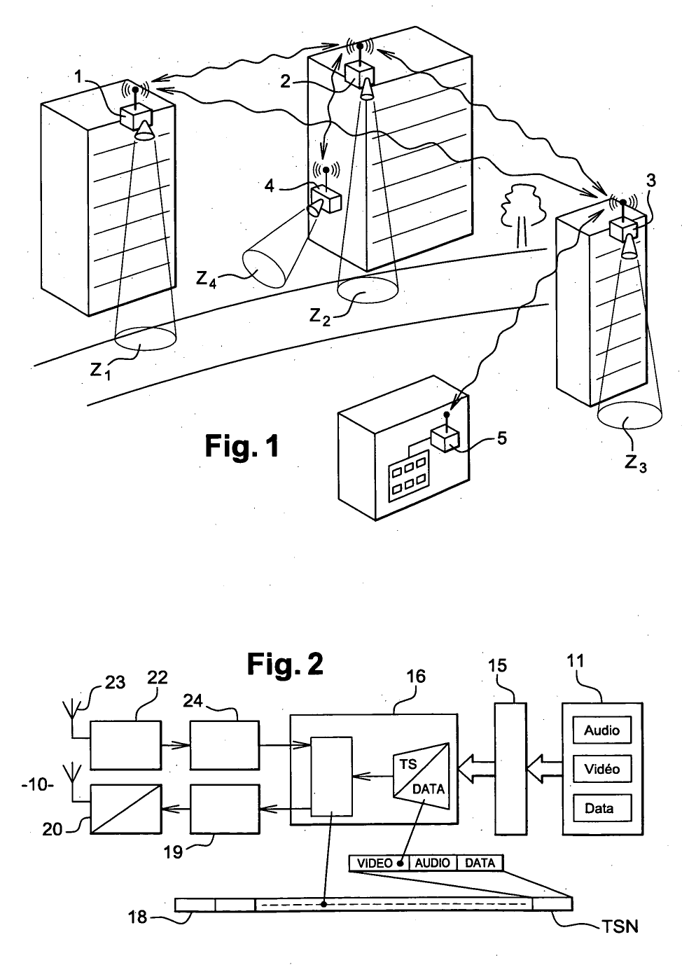

In this case, as shown in FIG. 1, several unitary devices (1, 2, 3, 4) can be installed in different buildings at particular locations in order to monitor specific areas Z1, Z2, Z3, Z4.

These transmission devices (1-4) are connected to each other via a digital radio link so as to form a network. This network may-be a meshed network between devices (1, 2, 3). Device (4) is located in an area where it is only within range of a single device (2) but this nevertheless makes it possible to link it to the network.

This network is also connected to a special device (5) that makes it possible to collect information and analyse it, e.g. in a remote monitoring centre.

Naturally, this remote monitoring centre can be linked to device (5) either directly or via a high bit rate data link, e.g. optical fibre cable.

As shown schematically in FIG. 2, a unitary device (10) comprises a video acquisition camera (11). This camera (11) produces a video signal to which an audio signal can be added, for example, as well as data that is specific to the camera, including, for example, the date and time of camera shots, various identifiers as well as parameters regarding the positioning and orientation of the camera.

This camera is connected to a compression stage (15) that is used to compress this various data whether it is video, audio or other data, in accordance with predefined formats. This format may preferably be the MPEG-4 or DivX-5 format for video data or the MPEG-1 format for audio signals.

The electronic circuitry inside the camera may perform compression so that the camera outputs a compressed signal.

This signal is then sent to a shaper stage (16). This signal ensures the framing (TSN) of the various signals produced by the camera (11) and compressed. Each of the basic frames (TSN) is then inserted into a general frame (18) by multiplexing.

The compression rate is in excess of 300 so as to limit the bandwidth used. In practice, this bandwidth is preferably less than 500 kbit per second for each of the unitary devices.

Subsequently, the general frame (18) thus obtained is sent to a modulation stage (19) that is used to ensure channel coding. Various types of coding can be used, especially those already mentioned and referred to by the abbreviations COFDM or WCDMA that are defined, in particular, in the ETS 300 744 Standard.

This digital modulation stage (19) is used to generate a signal that is then sent to a radio-frequency modulation stage (20) that is used to generate the hertzian signal that is transmitted by the antenna (21).

This signal is typically in the 2.4 GHz or 5 GHz frequency bands but this is not a crucial issue in the embodiment of this invention.

Device (10) is also capable of receiving information originating from similar devices via receiver stage (22) which demodulates the signal received via the antenna (23).

This signal is then sent to a demodulator that ensures channel decoding (24). This stage (24) decodes the received signal in order to apply the general frame to shaper stage (16). Device (16) injects, as already stated, the data relating to the new images acquired by camera (11) into this decoded general frame.

It is apparent from the above description that the device in accordance with the invention has numerous advantages, especially in that it makes it possible to implement networks of cameras and, more generally, systems making it possible to transport video data or data derived therefrom with the possibility of maintaining a particularly high bit rate (typically of the order of 512 kbit/s) and sufficient for a large number of cameras (typically several dozen).

### INDUSTRIAL APPLICATIONS

This device is especially suitable for performing remote monitoring tasks whether in dwellings in multiple occupancy, special areas such as car parks, shopping malls and other public places where security needs are important.

Special designs of the devices can be mounted on mobile vehicles such as buses, underground trains, trains, armoured vans and similar vehicles.

The device according to the invention can also be installed very quickly in order to obtain coverage in public or private locations in the context of organising events.

1. A device for digital radio transmission of data including video information, comprising:
a video acquisition camera,
a compression stage for generating a digital compressed video signal from a signal output by the video acquisition camera with a compression rate at least in excess of 1:300,
a shaper stage for inserting the compressed video signal into a frame,
a digital modulation stage for generating a digital radio signal, and
a transceiver stage for transmitting the digital radio signal in a predetermined frequency band to similar transmission devices and capable of for receiving signals that include frames having the same structure transmitted by similar devices.

2. A device as claimed in claim 1, wherein the video acquisition camera generates an analog signal.

3. A device as claimed in claim 1, wherein the video acquisition camera generates a digital signal.

4. A device as claimed in claim 1, wherein the compression stage is incorporated in the video acquisition camera.

5. A device as claimed in claim 1, wherein the compression stage uses MPEG-4 format compression algorithms.

6. A device as claimed in claim 1, further comprising means for modifying a viewing angle of the camera remotely.

7. A device as claimed in claim 1, wherein the digital modulation stage uses Coded Orthogonal Frequency Division Multiplexing (COFDM).

8. A device as claimed in claim 1, wherein the digital modulation stage uses Wideband Code Division Multiple Access (WCDMA).

9. A device as claimed in claim 1, wherein the transceiver stage operates in single-frequency network or multiple-frequency network mode.
